(19) United States
(12) Patent Application Publication
(10) Pub. No.: US 2006/0130376 A1
(43) Pub. Date: Jun. 22, 2006

(54) Advertising Poster Inside or in the Delivering Packing of Garments Processed by Dry Cleaning Establishments, Laundries or Similar Treatment

(75) Inventor: Jose Javier Vazquez Coria, Pachuca (MX)

Correspondence Address: CHRISTOPHER J. KULISH, ESQ, HOLLAND & HART LLP, P. O. BOX 8749, DENVER, CO, 80201-8749, US

(73) Assignee: CORIA COMERCIAL, S.A. DE C.V., Pachuca (MX)

(21) Appl. No.: 10/905,154

(22) Filed: Dec. 17, 2004

(51) Int. Cl. G09F 3/00

(52) U.S. Cl. 40/322

(57) ABSTRACT

This invention is directed to a process for distributing printed publicity by means of an advertising poster in the service orders of dry cleaning establishments, laundries and similar industry. The advertising poster will have the object to offer directed publicity spaces to a particular population sector, to which the companies, marks, business or commercial establishment wish to arrive. The advertising poster is comprised of a printed surface of the same or similar size than that of the protecting bag in which the processed garments are packed by the dry cleaning establishments, laundries or companies effecting similar processes or related to the garment cleaning, conservation or treatment. The advertising poster size, will be that which better fits to the protecting bag standard sizes, they may be the sizes of 50 cm×70 cm, 60 cm×90 cm, 60 cm×1.40 m, without prejudice to use that or those sizes that would be more convenient to reach the object of the invention. The printed surface may be adhered to the bag which has been mentioned, or to the hook, perch or hanger in which the garments are provided to the client.

### BACKGROUND OF THE INVENTION

In the advertisement business, there are several ways to let know the company product, however, to direct publicity to the proper market every time has become a greater challenge, that is to say, to the one that in fact is going to consume the specific product, either by its demographic, social, cultural and economical features or of any other nature.

At the present time, the directed publicity has every time a higher cost, represented by the high cost that represents to give it direction, it is to say, to offer it to the target public.

In order to offer the publicity to the target public, it has been development this product, since it is an innovative product and different to all the ones existing in the market, since this product functions more efficiently than other similar product.

### SUMMARY OF THE INVENTION

This is about an advertisement poster, announcement or advertising publication printed in different forms and by different methods, which have the intention to be distributed by means of service orders of dry cleaning establishments, laundries or similar services, and that it has the object to put in the hands of consumers of a specific social, economical, cultural and demographic level, the publicity and promotions of marks and establishments having particular interest in this public.

### BRIEF DESCRIPTION OF THE DRAWINGS

FIG. 1 illustrates an embodiment of an advertising poster;

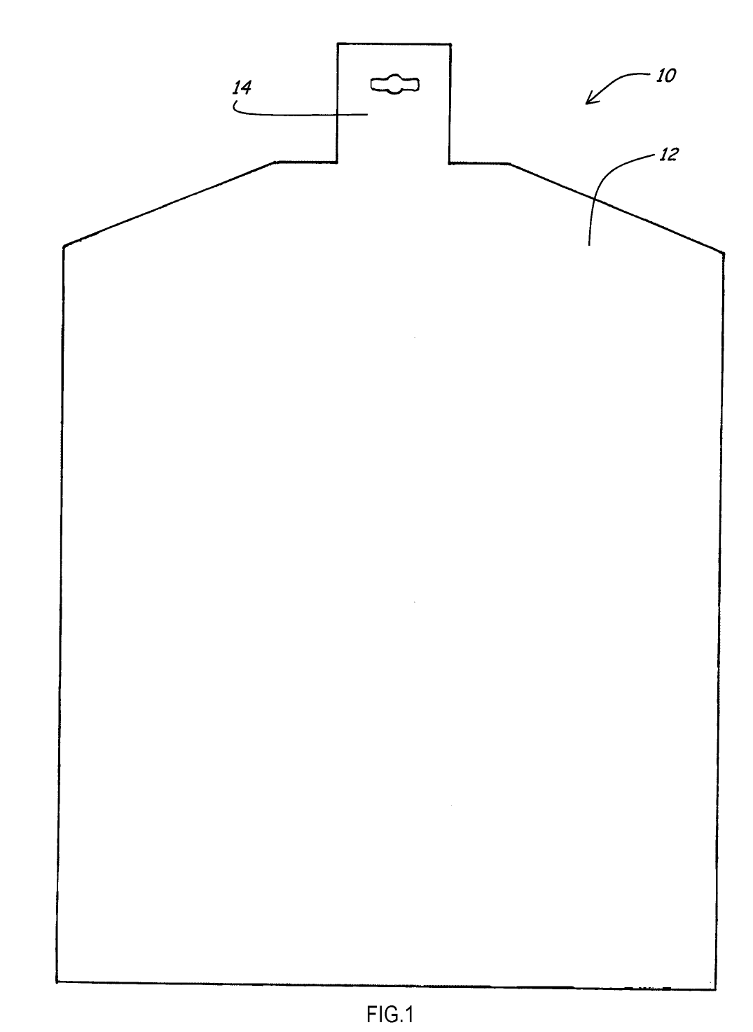

FIG. 2 illustrates the advertising poster of FIG. 1 with advertisements located on the printed surface thereof; and

FIG. 3 illustrates the advertising poster of FIG. 2 located inside a typical plastic bag and associated with a hanger.

### DETAILED DESCRIPTION

An advertising poster 10 is comprised by a printed surface 12, of the same or similar size than that of the protecting bag in which the processed garments are packed by the dry cleaning establishments or any company effecting similar processes. The poster 10 further comprises a tab 14 with a hole for receiving the hook portion of a hanger.

The size of the advertisement poster will be that which better fits to the protecting bag measures of each establishment, they may be in some preferred embodiments of: (I) 50 cm×70 cm, (II) 60 cm×90 cm and (III) 60 cm×140 cm. The last mentioned without detriment to use diverse sizes according to the convenience of the parties.

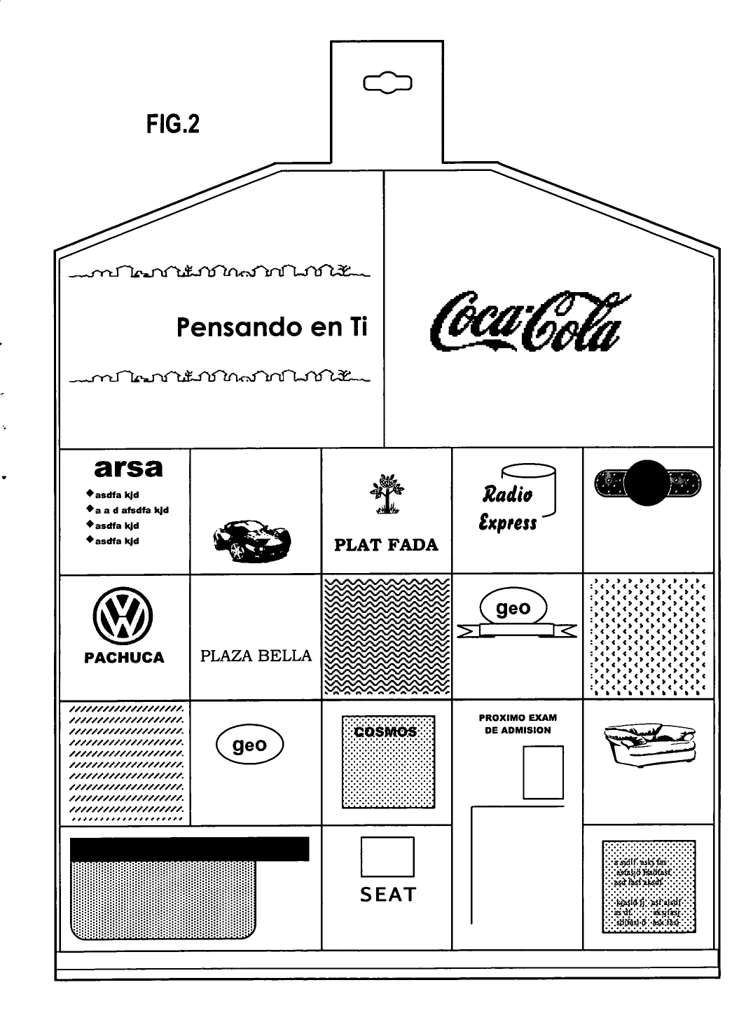

The advertisement poster printed surface 12 is appointed to place publicity, where there may be cutting coupons, promotions, commercial advertisements or any similar thing. FIG. 2 illustrates a poster 10 with advertisements located on the printed surface 12. The poster 10 has up to 22 spaces for advertisements. A greater or lesser number of spaces is possible.

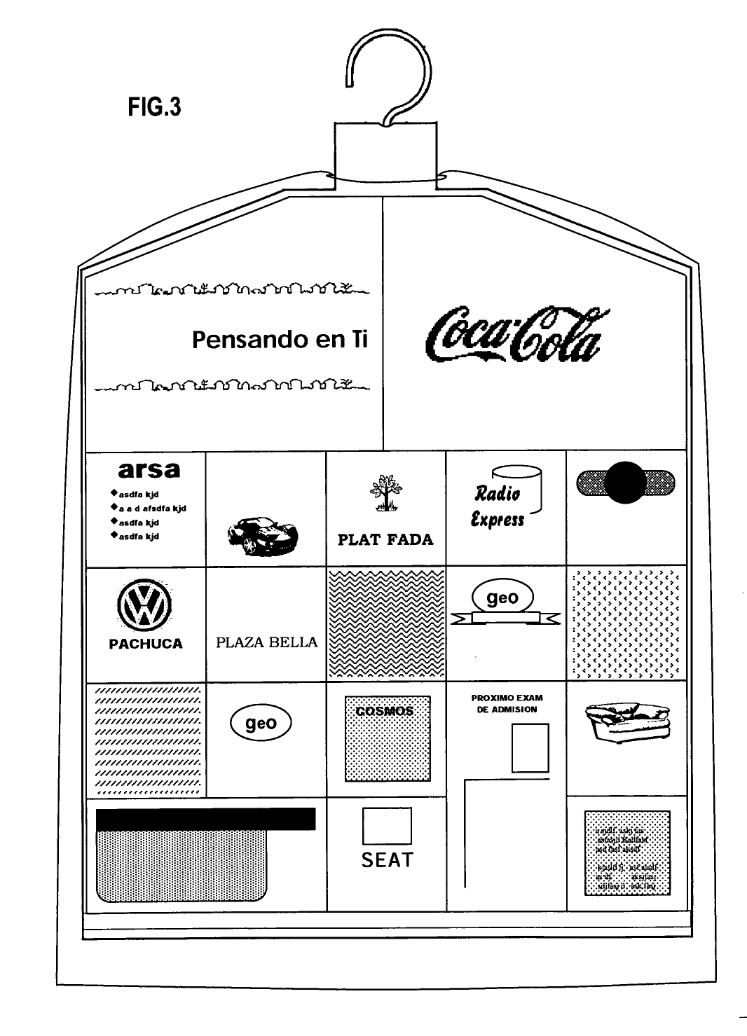

The printed surface 12 may be adhered to the protective bag of the clothes (in which case, the tab 14 may not be unnecessary) or to the hook, perch or hanger, in which the clothes are returned to the client. FIG. 3 illustrates the advertising poster 10 with advertisements located on the printed surface 12 and the tab 14 engaged by a hanger. Further the poster 10 is disposed under a substantially transparent, plastic covering that dry cleaning establishments and the like use to protect garments that have been cleaned.

The efficiency and innovation of the advertising poster resides in that it is directed to a public that, due to its social, demographic, cultural and economic features, is of interest for advertisers requiring the directed publicity advantages.

The present invention uses a space that was not being previously used for commercial purposes, with the advantage as opposed to any other type of advertising poster that it has a frontal impact before the customer.

The extra service provided to the client by the invention is that it receives publicity of business and companies in which it may have a particular interest, at the same time that it picks up the garment(s) that it has deposited in the company for this purpose.

The advertising poster may be made in any kind of paper, or in any other material in which it is possible to print publicity.

The advertising poster divisions, subdivisions and design are left to the consideration and specific needs of each client.

1-6. (canceled)

7. An advertising poster for use with a clothing hanger that has (a) a clothing support member that is adapted to engage an item of clothing and has a lateral extent and (b) a hook member that is operatively attached to the clothing engagement member, the poster comprising:
a planar member for bearing at least one advertisement, said planar member having a planar member lateral extent that is substantially equal to the lateral extent of a clothing support member of a hanger and a planar member longitudinal extent that is greater than said planar member lateral extent; and
an engagement structure with a first portion that is operatively attached to said planar member and a second portion for operatively connecting said planar member to a hanger.

8. An advertising poster, as claimed in claim 7, wherein:
said planar member comprises a first planar side and a second planar side that is substantially parallel to said first planar side;
wherein one or more advertisements are located only on said first planar side and substantially anywhere on said first planar side.

9. An advertising poster, as claimed in claim 7, wherein:
said planar member comprises a rectangular portion and an isosceles trapezoid portion that is operatively connected to said rectangular portion.

10. An advertising poster, as claimed in claim 9, wherein:
said engagement structure comprises a tab that is operatively attached to said isosceles trapezoid portion of said planar member, said tab defining a hole for receiving a hook member of a hanger.

11. An advertising poster, as claimed in claim 7, wherein:
said engagement structure comprises a tab that is operatively attached to said said planar member, said tab defining a hole for receiving a hook member of a hanger.

12. An advertising poster, as claimed in claim 7, wherein:
said engagement member comprises an adhesive for attaching said planar member to a plastic bag that is used to cover a least a portion of an item of clothing that is supported by a hanger.
